(19) United States
(12) Patent Application Publication
(10) Pub. No.: US 2013/0048253 A1
(43) Pub. Date: Feb. 28, 2013

(54) HEAT DISSIPATION DEVICE AND METHOD OF MANUFACTURING SAME

(71) Applicant: Hsiu-Wei Yang, New Taipei City (TW)

(72) Inventor: Hsiu-Wei Yang, New Taipei City (TW)

(73) Assignee: ASIA VITAL COMPONENTS CO., LTD., New Taipei City (TW)

(21) Appl. No.: 13/274,359

(22) Filed: Oct. 17, 2011

(30) Foreign Application Priority Data
Aug. 29, 2011 (TW) 100130953

(51) Int. Cl. F28D 15/04; B23P 15/26

(52) U.S. Cl. 165/104.26; 29/890.054

(57) ABSTRACT

A heat dissipation device includes a heat dissipation element and a ceramic main body. The heat dissipation element includes a heat transfer section and a heat dissipation section located on one side of the heat transfer section; and the ceramic main body is directly connected to another side of the heat transfer section opposite to the heat dissipation section by way of welding or a direct bonding copper process, so as to overcome the problem of crack at an interface between the heat dissipation device and a heat source due to thermal fatigue. A method of manufacturing the above-described heat dissipation device is also disclosed.

This application claims the priority benefit of Taiwan patent application number 100130953 filed on Aug. 29, 2011.

### FIELD OF THE INVENTION

The present invention relates to a heat dissipation device, and more particularly to a heat dissipation device having a heat dissipation element being directly connected at a heat transfer section to an element made of a ceramic material, so as to overcome the problem of crack at an interface between the heat dissipation element and a heat source due to thermal fatigue. The present invention also relates to a method of manufacturing the above described heat dissipation device.

### BACKGROUND OF THE INVENTION

The progress in semiconductor technology enables various integrated circuits (ICs) to have a gradually reduced volume. For the purpose of processing more data, the number of computing elements provided on the presently available ICs is several times higher than that on the conventional ICs of the same volume. When the number of computing elements on the ICs increases, the heat generated by the computing elements during the operation thereof also increases. For example, the heat generated by a central processing unit (CPU) at full-load condition is high enough to burn out the whole CPU. Thus, it is always an important issue to properly provide a heat dissipation device for ICs.

The CPU and other chips are heat sources in the electronic device. When the electronic device operates, these heat sources will generate heat. The CPU and other chips are mainly encapsulated with a ceramic material. The ceramic material has a low thermal expansion coefficient close to that of chips used in general electronic devices and is electrically non-conductive, and is therefore widely employed as packaging material and semiconductor material.

On the other hand, a heat dissipation device usually includes a heat dissipating structure made of an aluminum material or a copper material, and is often used along with other heat dissipation elements, such as fans and heat pipes, in order to provide enhanced heat dissipation effect. However, in considering the reliability of the electronic device, the use of a heat dissipation structure with cooling fans and heat pipes would usually have adverse influence on the overall reliability of the electronic device.

Generally speaking, a heat dissipation device with simpler structural design would be better to the overall reliability of the electronic device. Thus, the heat transfer efficiency of the electronic device can be directly improved when the heat dissipation device used therewith uses a material having better heat transferring and radiating ability than copper.

In addition, heat stress is another potential factor having adverse influence on the reliability of the electronic device in contact with the heat dissipation device. The heat source, such as the chip in the CPU, has a relatively low thermal expansion coefficient. To pursue good product reliability, the electronic device manufacturers would usually use a ceramic material with low thermal expansion coefficient, such as aluminum nitride (AlN) or silicon carbide (SiC), to package the chip.

Further, in the application field of light-emitting diode (LED) heat dissipation, for example, aluminum and copper materials forming the heat dissipation device have thermal expansion coefficients much higher than that of an LED sapphire chip and the ceramic packaging material thereof. In a high-brightness LED, an interface between the aluminum or copper material of the heat dissipation device and the ceramic packaging material of the LED sapphire chip tends to crack due to thermal fatigue caused by the difference in the thermal expansion coefficients thereof when the LED has been used over a long period of time. The interface crack in turn causes a rising thermal resistance at the interface. For the high-brightness LED products, the rising thermal resistance at the heat dissipation interface would result in heat accumulation to cause burnout of the LED chip and bring permanent damage to the LED.

In brief, the difference between the thermal expansion coefficients of the ceramic packaging material of a heat source and the metal material of a heat dissipation device would cause crack at an interface between the heat source and the heat dissipation device due to thermal fatigue; and it is necessary to work out a way to solve the problem of such crack at the interface.

### SUMMARY OF THE INVENTION

A primary object of the present invention is to provide a heat dissipation device that overcomes the problem of crack at an interface between the heat dissipation device and a heat source due to thermal fatigue.

Another object of the present invention is to provide a method of manufacturing a heat dissipation device that can overcome the problem of crack at an interface between the heat dissipation device and a heat source due to thermal fatigue.

To achieve the above and other objects, the heat dissipation device according to the present invention includes a heat dissipation element and a ceramic main body. The heat dissipation element includes a heat transfer section and a heat dissipation section located on one side of the heat transfer section; and the ceramic main body is connected to another side of the heat transfer section opposite to the heat dissipation section.

In the present invention, the heat dissipation element can be any one of a heat sink, a vapor chamber, a heat pipe, and a water block.

In the present invention, the ceramic main body is made of a material selected from the group consisting of silicon nitride (Si₃N₄), zirconium nitride (ZrO₂), and aluminum oxide (Al₂O₃).

To achieve the above and other objects, the heat dissipation device manufacturing method according to the present invention includes the following steps:

providing a heat dissipation element and a ceramic main body; and

connecting the heat dissipation element and the ceramic main body to each other.

In the present invention, the heat dissipation element and the ceramic main body are connected to each other in a manner selected from the group consisting of soldering, brazing, diffusion bonding, ultrasonic welding, and direct bonding copper (DBC) process.

In the present invention, since the ceramic main body is directly connected to the heat dissipation element for contacting with a ceramic packaging material of a heat source, it is able to avoid the problem of crack at an interface between the heat dissipation device and the heat source due to thermal fatigue caused by different thermal expansion coefficients of the heat dissipation element and the heat source package.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1a is an exploded perspective view of a heat dissipation device according to a first embodiment of the present invention;

FIG. 1b is an assembled view of FIG. 1;

FIG. 2 is a front view of FIG. 1b;

FIG. 3 is an exploded perspective view of a heat dissipation device according to a second embodiment of the present invention;

FIG. 4 is an assembled view of FIG. 3;

FIG. 5 is a cross sectional view of a heat dissipation device according to a third embodiment of the present invention;

FIG. 6 is an exploded perspective view of a heat dissipation device according to a fourth embodiment of the present invention;

FIG. 7 is an assembled view of FIG. 6; and

FIG. 8 is a flowchart showing the steps included in a method of manufacturing heat dissipation device according to the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

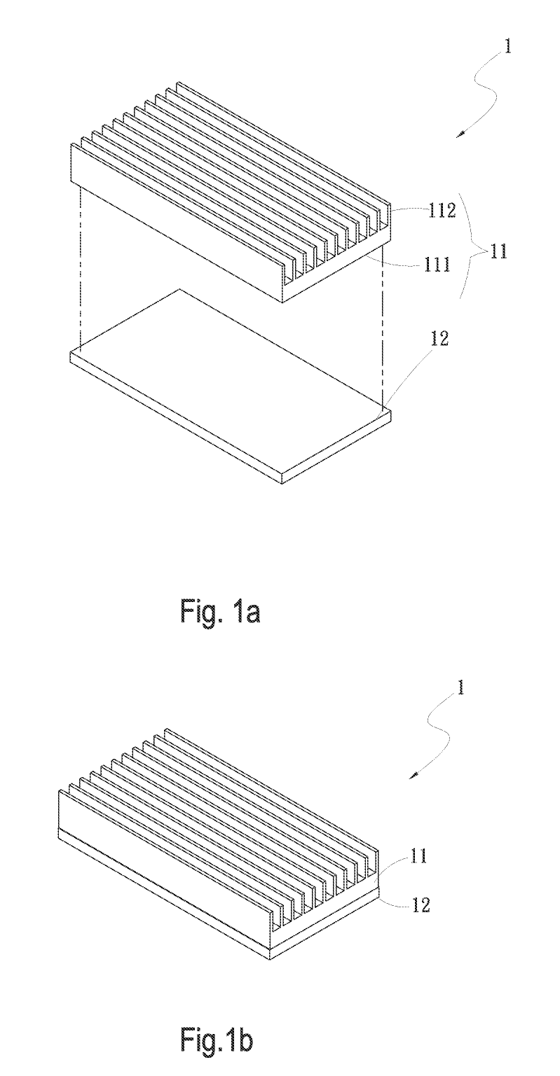

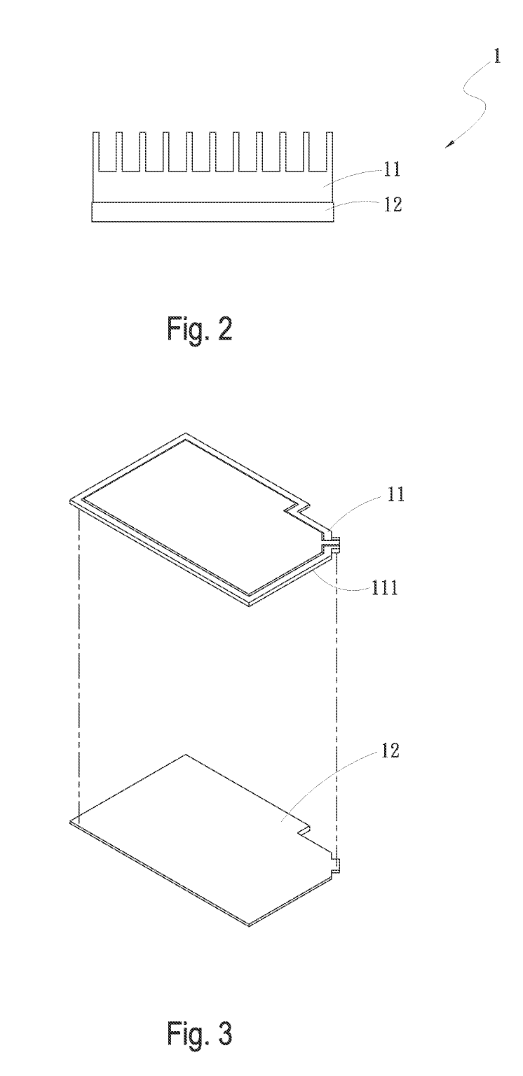

Please refer to FIGS. 1a and 1b that are exploded and assembled perspective views, respectively, of a heat dissipation device according to a first embodiment of the present invention, and to FIG. 2 that is a front view of FIG. 1b. As shown, the heat dissipation device is generally denoted by reference numeral 1, and includes a heat dissipation element 11 and a ceramic main body 12.

The heat dissipation element 11 includes a heat transfer section 111 and a heat dissipation section 112 located on one side of the heat transfer section 111. The ceramic main body 12 is connected to another side of the heat transfer section 111 opposite to the heat dissipation section 112. In the illustrated first embodiment, the heat dissipation element 11 is a heat sink, and the ceramic main body 12 is made of a material selected from the group consisting of silicon nitride (Si₃N₄), zirconium nitride (ZrO₂), and aluminum oxide (Al₂O₃).

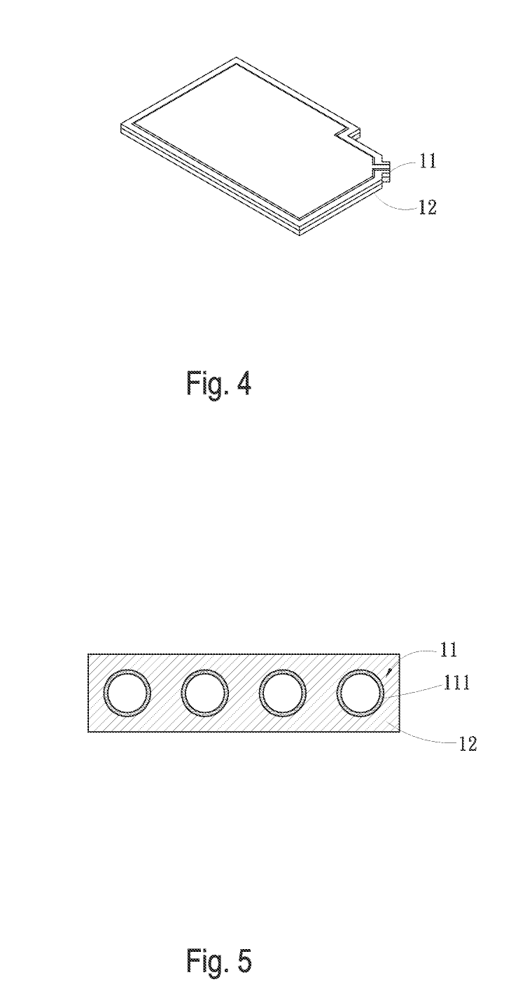

Please refer to FIGS. 3 and 4 that are exploded and assembled perspective views, respectively, of a heat dissipation device according to a second embodiment of the present invention. As shown, the second embodiment is generally structurally similar to the first embodiment, except that the heat dissipation element 11 in the second embodiment is a vapor chamber. And, the ceramic main body 12 is similarly connected to the heat transfer section 111 of the heat dissipation element 11.

FIG. 5 is a cross sectional view of a heat dissipation device according to a third embodiment of the present invention. As shown, the third embodiment is generally structurally similar to the first embodiment, except that the heat dissipation element 11 in the third embodiment is a heat pipe. And, the ceramic main body 12 is similarly connected to the heat transfer section 111 of the heat dissipation element 11.

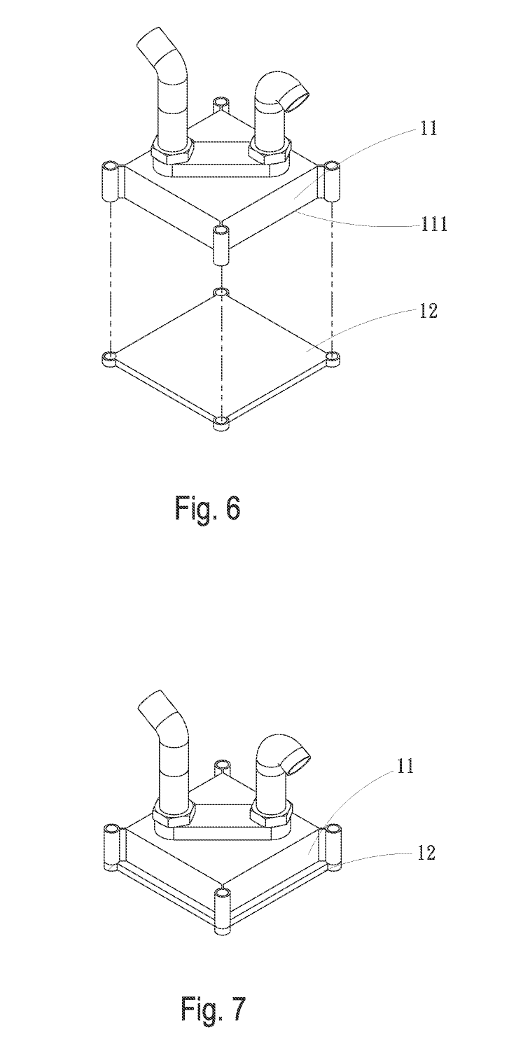

Please refer to FIGS. 6 and 7 that are exploded and assembled perspective views, respectively, of a heat dissipation device according to a fourth embodiment of the present invention. As shown, the fourth embodiment is generally structurally similar to the first embodiment, except that the heat dissipation element 11 in the fourth embodiment is a water block. And, the ceramic main body 12 is similarly connected to the heat transfer section 111 of the heat dissipation element 11.

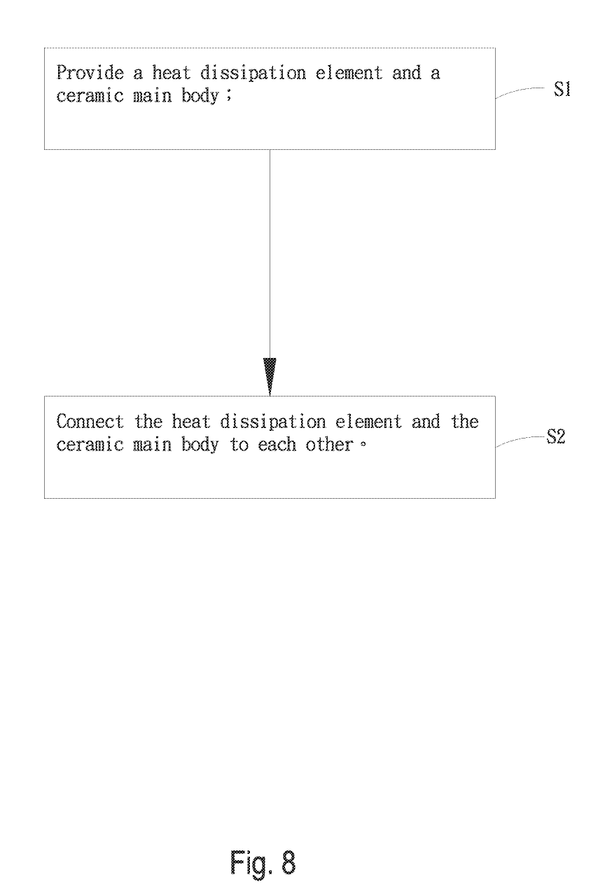

FIG. 8 is a flowchart showing the steps included in a method of manufacturing heat dissipation device according to an embodiment of the present invention. Please refer to FIG. 8 along with FIGS. 1 to 7. The heat dissipation device manufacturing method of the present invention includes the following steps S1 and S2.

In the step S1, a heat dissipation element and a ceramic main body are provided.

More specifically, a heat dissipation element 11 and a ceramic main body 12 are provided. The heat dissipation element 11 can be any one of a heat sink, a vapor chamber, a heat pipe, and a water block. The ceramic main body 12 is made of a material selected from the group consisting of silicon nitride (Si₃N₄), zirconium nitride (ZrO₂), and aluminum oxide (Al₂O₃).

In the step S2, the heat dissipation element and the ceramic main body are connected to each other.

More specifically, the heat dissipation element 11 and the ceramic main body 12 are connected to each other by way of soldering, brazing, diffusion bonding, ultrasonic welding, or direct bonding copper (DBC) process.

The present invention is characterized in that the heat dissipation element 11, which can be a heat sink, a vapor chamber, a heat pipe or a water block, has a heat transfer section 111 for transferring heat from a heat source to a heat dissipation 112; and that the ceramic main body 12 is connected to the heat transfer section 111 of the heat dissipation element 11 for contacting with the heat source. Since the ceramic main body 12 has a thermal expansion coefficient close to that of a ceramic packaging material of the heat source, it is able to avoid the problem of crack at an interface between the heat dissipation element 11 and the heat source due to thermal fatigue caused by different thermal expansion coefficients of the heat dissipation element 11 and the heat source package. Further, the heat dissipation element with the ceramic main body connected to the heat transfer section thereof can be applied to more different fields.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A heat dissipation device, comprising a heat dissipation element and a ceramic main body; the heat dissipation element including a heat transfer section and a heat dissipation section located on one side of the heat transfer section; and the ceramic main body being connected to another side of the heat transfer section opposite to the heat dissipation section.

2. The heat dissipation device as claimed in claim 1, wherein the heat dissipation element is selected from the group consisting of a heat sink, a vapor chamber, a heat pipe, and a water block.

3. The heat dissipation device as claimed in claim 1, wherein the ceramic main body is made of a material selected from the group consisting of silicon nitride (Si₃N₄), zirconium nitride (ZrO₂), and aluminum oxide (Al₂O₃).

4. The heat dissipation device as claimed in claim 1, wherein the heat dissipation element and the ceramic main body are connected to each other in a manner selected from the group consisting of soldering, brazing, diffusion bonding, ultrasonic welding, and direct bonding copper (DBC) process.

5. A method of manufacturing heat dissipation device, comprising the following steps:
providing a heat dissipation element and a ceramic main body; and
connecting the heat dissipation element and the ceramic main body to each other.

6. The method of manufacturing heat dissipation device as claimed in claim 5, wherein the heat dissipation element and the ceramic main body are connected to each other in a manner selected from the group consisting of soldering, brazing, and ultrasonic welding.

7. The method of manufacturing heat dissipation device as claimed in claim 5, wherein the heat dissipation element and the ceramic main body are connected to each other by way of diffusion bonding.

8. The method of manufacturing heat dissipation device as claimed in claim 5, wherein the ceramic main body is made of a material selected from the group consisting of silicon nitride (Si₃N₄), zirconium nitride (ZrO₂), and aluminum oxide (Al₂O₃).

9. The method of manufacturing heat dissipation device as claimed in claim 5, wherein the heat dissipation element and the ceramic main body are connected to each other by way of direct bonding copper (DBC) process.

10. The method of manufacturing heat dissipation device as claimed in claim 5, wherein the heat dissipation element is selected from the group consisting of a heat sink, a vapor chamber, a heat pipe, and a water block.
